(19) United States
(12) Patent Application Publication
(10) Pub. No.: US 2018/0137192 A1
(43) Pub. Date: May 17, 2018

(54) METHOD AND SYSTEM FOR PERFORMING A HIERARCHICAL CLUSTERING OF A PLURALITY OF ITEMS

(71) Applicant: 1QB INFORMATION TECHNOLOGIES INC., Vancouver (CA)

(72) Inventors: Arman ZARIBAFIYAN, Vancouver (CA); Elham Alipour Khayer, Vancouver (CA); Clemens Adolphs, Vancouver (CA); Maxwell Rounds, Vancouver (CA)

(73) Assignee: 1QB INFORMATION TECHNOLOGIES INC., Vancouver (CA)

(21) Appl. No.: 15/809,456

(22) Filed: Nov. 10, 2017

Related U.S. Application Data
(60) Provisional application No. 62/420,769, filed on Nov. 11, 2016.

(51) Int. Cl. G06F 17/30

(52) U.S. Cl. CPC G06F 17/30598; G06N 99/005

(57) ABSTRACT

A method and a system are disclosed for determining a hierarchical clustering for a group comprising a plurality of items. The method comprises providing an indication of a similarity matrix for a plurality of items; generating an optimization problem for determining a list of at least one permutation of items in the similarity matrix such that the similarity matrix is quasi-block diagonalized with the at least one permutation of items; transmitting an indication of the optimization problem to a given optimization oracle; obtaining an indication of a solution to the optimization problem from the given optimization oracle; reordering the similarity matrix using the list of at least one permutation of items; creating a hierarchical clustering tree using the reordered similarity matrix wherein the dividing of a node comprising a given number of items into two clusters comprises selecting a submatrix of the reordered similarity matrix associated with the given number of items, evaluating possible split points, choosing a given split point according to a criterion and generating the two clusters using the chosen split point; and providing an indication of the hierarchical clustering tree.

### CROSS-REFERENCE TO RELATED APPLICATION

The present patent application claims the benefit of U.S. Provisional Patent Application No. 62/420,769, filed on Nov. 11, 2016 by the present applicant.

### FIELD OF THE INVENTION

The invention relates to computers. More precisely, the invention pertains to a method and system for performing a hierarchical clustering of a plurality of items.

### BACKGROUND OF THE INVENTION

Being able to perform a hierarchical clustering of a plurality of items is of great importance.

In fact, building hierarchical clustering trees has many applications in various fields such as finance, marketing, biology and machine learning.

For instance, in the case where the items are assets, the performing of a hierarchical clustering of the plurality of assets can be used for determining a weight allocation in a portfolio, which is of great advantage for asset managers.

Two general approaches are used for creating hierarchical clustering trees.

A first approach is referred to as an agglomerative or bottom-up approach. According to a first step, each item is assigned in its own cluster and then pairs of clusters are merged based on a chosen criterion as one moves up the hierarchy.

A second approach is referred to as a divisive or top-down approach. According to a first step, all items are put in one cluster and as one goes down the tree, the items are then recursively divided into two or more clusters.

One disadvantage of agglomerative hierarchical clustering is that it usually results in very unbalanced trees.

Another disadvantage of this approach is that it typically has poor performance near the top of the tree (more important steps). In other words the best choice for merging two clusters on a high-level step is likely to be poorer than the global optimum theoretically possible for that step. The skilled addressee will appreciate that this problem gets worse for larger datasets, which is of great disadvantage.

Prior-art methods for building a divisive hierarchical clustering tree may use clustering methods such as weighted max-cut clustering at each level of the tree to divide the set of items into two or more clusters. One disadvantage of using weighted max-cut clustering is that it usually provides a very balanced tree.

Features of the invention will be apparent from review of the disclosure, drawings, and description of the invention below.

### BRIEF SUMMARY OF THE INVENTION

According to a broad aspect, there is disclosed a computer-implemented method for determining a hierarchical clustering for a group comprising a plurality of items, the method comprising use of a processing device for: providing an indication of a similarity matrix for a plurality of items; generating an optimization problem for determining a list of at least one permutation of items in the similarity matrix such that the similarity matrix is quasi-block diagonalized with the at least one permutation of items; transmitting an indication of the optimization problem to a given optimization oracle, wherein the optimization oracle comprises a digital computer embedding a binary quadratic programming problem as an Ising spin model, and an analog computer that carries out an optimization of a configuration of spins in the Ising spin model; obtaining an indication of a solution to the optimization problem from the given optimization oracle, the indication of a solution comprising the list of at least one permutation of items; reordering the similarity matrix using the list of at least one permutation of items; creating a hierarchical clustering tree using the reordered similarity matrix wherein the dividing of a node comprising a given number of items of the hierarchical clustering tree into two clusters comprises selecting a submatrix of the reordered similarity matrix associated with the given number of items, evaluating possible split points, choosing a given split point according to a criterion and generating the two clusters using the chosen split point and providing an indication of the hierarchical clustering tree.

According to an embodiment, the indication of a similarity matrix is provided by a user interacting with the processing device.

According to an embodiment, the indication of a similarity matrix is obtained from a memory unit of the processing device.

According to an embodiment, the indication of a similarity matrix is obtained from a remote processing device operatively connected with the processing device using a data network.

According to an embodiment, the providing of an indication of a similarity matrix for a plurality of items comprises generating the similarity matrix using a list of the plurality of items.

According to an embodiment, the optimization problem is converted into an optimization problem suitable for the optimization oracle.

According to an embodiment, the optimization problem comprises an objective function.

According to an embodiment, the objective function is translated in a quadratic unconstrained binary optimization problem.

According to an embodiment, the obtaining of an indication of a solution to the optimization problem from the given optimization oracle comprises performing a post-processing to improve the solution.

According to an embodiment, the criterion comprises minimizing a matrix measure associated with the selected submatrix.

According to an embodiment, the matrix measure comprises a mean absolute value of off-diagonal blocks' entries of the selected submatrix.

According to an embodiment, the matrix measure comprises a Frobenius norm of off-diagonal blocks' entries of the selected submatrix.

According to an embodiment, the indication of the hierarchical clustering tree is stored in a memory unit of the processing device.

According to an embodiment, the indication of the hierarchical clustering tree is transmitted to a remote processing device operatively connected to the processing device.

According to a broad aspect, there is disclosed a processing device for determining a hierarchical clustering for a group comprising a plurality of items, the processing device comprising: a central processing unit; a display device; a communication port; a memory unit comprising an application for determining a hierarchical clustering for a group comprising a plurality of items, the application comprising instructions for providing an indication of a similarity matrix for a plurality of items; instructions for generating an optimization problem for determining a list of at least one permutation of items in the similarity matrix such that the similarity matrix is quasi-block diagonalized with the at least one permutation of items; instructions for transmitting an indication of the optimization problem to a given optimization oracle operatively connected to the processing device using the communication port, wherein the optimization oracle comprises a digital computer embedding a binary quadratic programming problem as an Ising spin model, and an analog computer that carries out an optimization of a configuration of spins in the Ising spin model; instructions for obtaining an indication of a solution to the optimization problem from the given optimization oracle, the indication of a solution comprising the list of at least one permutation of items; instructions for reordering the similarity matrix using the list of at least one permutation of items; instructions for creating a hierarchical clustering tree using the reordered similarity matrix wherein the dividing of a node comprising a given number of items into two clusters comprises selecting a submatrix of the reordered similarity matrix associated with the given number of items, evaluating possible split points, choosing a given split point according to a criterion and generating the two clusters using the chosen split point; and instructions for providing an indication of the hierarchical clustering tree and a data bus for interconnecting the central processing unit, the display device, the communication port and the memory unit.

According to a broad aspect, there is disclosed a non-transitory computer-readable storage medium for storing computer-executable instructions which, when executed, cause a processing device to perform a method for determining a hierarchical clustering for a group comprising a plurality of items, the method comprising providing an indication of a similarity matrix for a plurality of items; generating an optimization problem for determining a list of at least one permutation of items in the similarity matrix such that the similarity matrix is quasi-block diagonalized with the at least one permutation of items; transmitting an indication of the optimization problem to a given optimization oracle, wherein the optimization oracle comprises a digital computer embedding a binary quadratic programming problem as an Ising spin model, and an analog computer that carries out an optimization of a configuration of spins in the Ising spin model; obtaining an indication of a solution to the optimization problem from the given optimization oracle, the indication of a solution comprising the list of at least one permutation of items; reordering the similarity matrix using the list of at least one permutation of items; creating a hierarchical clustering tree using the reordered similarity matrix wherein the dividing of a node comprising a given number of items into two clusters comprises selecting a submatrix of the reordered similarity matrix associated with the given number of items, evaluating possible split points, choosing a given split point according to a criterion and generating the two clusters using the chosen split point and providing an indication of the hierarchical clustering tree.

According to a broad aspect, there is disclosed a method for determining allocation weights for a plurality of items, the method comprising: obtaining an indication of historical time series data for a plurality of items; computing a covariance matrix of the plurality of items to provide a similarity matrix between the items of the plurality of items; generating a hierarchical tree for the plurality of items according to the above-mentioned computer-implemented method using the similarity matrix; updating allocation weights recursively using the generated hierarchical tree and providing an indication of the allocation weights.

An advantage of the method disclosed herein is that it provides a global optimum answer for quasi-block-diagonalization of the similarity matrix. Both the agglomerative approach and other conventional divisive approaches lead to a suboptimal answer for the problem of finding a quasi-block-diagonalized similarity matrix.

Another advantage of the method disclosed herein is that it is not biased towards cluster sizes. Therefore, it can provide a more suitable hierarchical clustering tree based on the original structure of the data.

Another advantage of the method disclosed herein is that it provides higher-quality results in a shorter amount of time compared to prior-art methods for determining weight allocation.

Another advantage of the method disclosed herein for determining weight allocation is that it does not need the covariance matrix to be non-singular.

Another advantage of the method disclosed herein for determining weight allocation is that it is more stable against numerical errors since the method disclosed does not involve inverting the covariance matrix.

An advantage of the method disclosed herein when applied for determining weight allocation is that the determined weight allocation minimizes risk. In the case where the items are assets, the determined weight allocation will help minimizing the risk of returns.

### BRIEF DESCRIPTION OF THE DRAWINGS

In order that the invention may be readily understood, embodiments of the invention are illustrated by way of example in the accompanying drawings.

FIG. 1 is a flowchart which shows an embodiment of a method for performing a hierarchical clustering of a plurality of items.

FIG. 2 is a flowchart which shows an embodiment for generating an optimization problem.

FIG. 3 is a flowchart which shows an embodiment for obtaining an indication of a solution.

FIG. 4 is a flowchart which shows an embodiment for creating a hierarchical clustering tree using the reordered similarity matrix.

FIG. 5 is a flowchart which shows an embodiment for setting the leaf as the parent and dividing it into two clusters of items.

FIG. 6 is a flowchart which shows an embodiment of a method for providing an indication of allocation weights.

FIG. 7 is a flowchart which shows an embodiment for updating the allocation weights recursively based on the rearranged covariance matrix.

FIG. 8 is a flowchart which shows an embodiment for computing the variance of the two nodes.

FIG. 9 is a diagram which shows a processing device which may be used for implementing a method for performing a hierarchical clustering of a plurality of items.

Further details of the invention and its advantages will be apparent from the detailed description included below.

### DETAILED DESCRIPTION OF THE INVENTION

In the following description of the embodiments, references to the accompanying drawings are by way of illustration of an example by which the invention may be practiced.

### Terms

The term “invention” and the like mean “the one or more inventions disclosed in this application,” unless expressly specified otherwise.

The terms “an aspect,” “an embodiment,” “embodiment,” “embodiments,” “the embodiment,” “the embodiments,” “one or more embodiments,” “some embodiments,” “certain embodiments,” “one embodiment,” “another embodiment” and the like mean “one or more (but not all) embodiments of the disclosed invention(s),” unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including,” “comprising” and variations thereof mean “including but not limited to,” unless expressly specified otherwise.

The terms “a,” “an,” “the” and “at least one” mean “one or more,” unless expressly specified otherwise.

The term “plurality” means “two or more,” unless expressly specified otherwise.

The term “herein” means “in the present application, including anything which may be incorporated by reference,” unless expressly specified otherwise.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example,” and thus do not limit the terms or phrases they explain. For example, in a sentence “the computer sends data (e.g., instructions, a data structure) over the Internet,” the term “e.g.” explains that “instructions” are an example of “data” that the computer may send over the Internet, and also explains that “a data structure” is an example of “data” that the computer may send over the Internet. However, both “instructions” and “a data structure” are merely examples of “data,” and other things besides “instructions” and “a data structure” can be “data.”

The term “i.e.” and like terms mean “that is,” and thus limit the terms or phrases they explain.

Neither the Title nor the Abstract is to be taken as limiting in any way as the scope of the disclosed invention(s). The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

It will be appreciated that the invention may be implemented in numerous ways. In this specification, these implementations, or any other form that the invention may take, may be referred to as systems or techniques. A component such as a processor or a memory described as being configured to perform a task includes either a general component that is temporarily configured to perform the task at a given time or a specific component that is manufactured to perform the task.

With all this in mind, the present invention is directed to a computer implemented method, a system and a computer-readable product for determining a hierarchical clustering for a group comprising a plurality of items.

In fact, it will be appreciated that the method for determining a hierarchical clustering for a group comprising a plurality of items may be implemented using a processing device, also referred to as a system.

In one embodiment, the processing device is selected from a group consisting of smartphones, laptop computers, desktop computers, servers, etc.

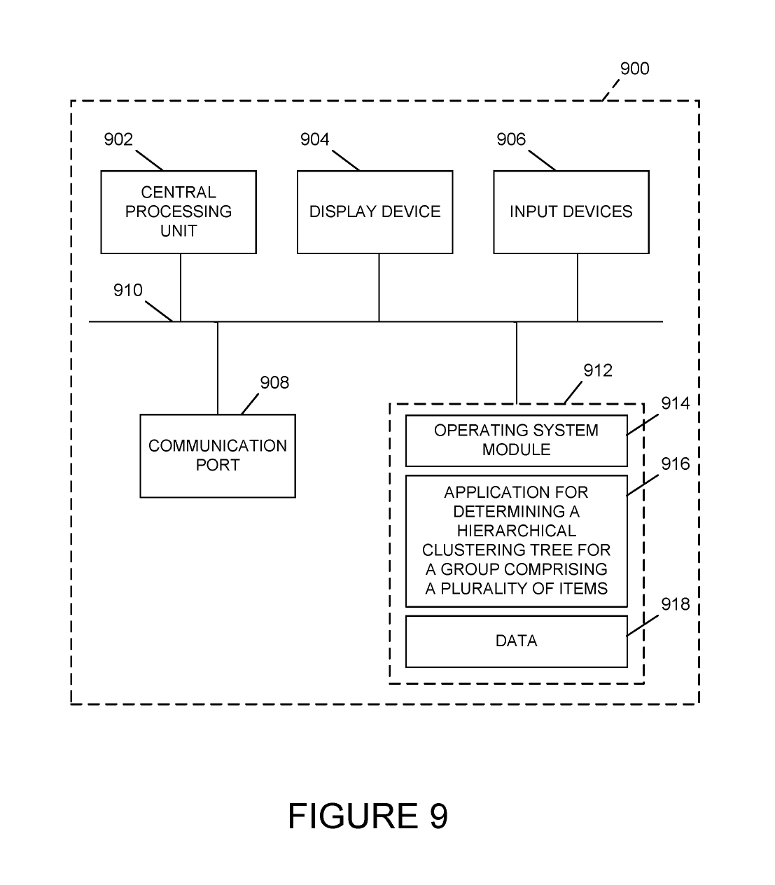

Now referring to FIG. 9, there is shown an embodiment of a processing device 900 which may be used for determining a hierarchical clustering for a group comprising a plurality of items.

In this embodiment, the processing device 900 comprises a central processing unit (CPU) 902, also referred to as a microprocessor, a display device 904, input devices 906, communication ports 908, a data bus 910 and a memory unit 912.

The central processing unit 902 is used for processing computer instructions. The skilled addressee will appreciate that various embodiments of the central processing unit 902 may be provided.

In one embodiment, the central processing unit 902 is a Core i5 Intel processor running at 2.5 GHz and manufactured by Intel™.

The display device 904 is used for displaying data to a user. The skilled addressee will appreciate that various types of display device may be used.

In one embodiment, the display device 904 is a standard liquid-crystal display (LCD) monitor.

The communication ports 908 are used for sharing data with the processing device 900. The communication ports 908 may also be used for enabling a connection with the quadratic solver, not shown.

The communication ports 908 may comprise, for instance, a universal serial bus (USB) port for connecting a keyboard and a mouse to the processing device 900.

The communication ports 908 may further comprise a data network communication port such as an IEEE 802.3 (Ethernet) port for enabling a connection of the processing device 900 with another processing device.

The skilled addressee will appreciate that various alternative embodiments of the communication ports 908 may be provided.

In one embodiment, the communication ports 908 comprise an Ethernet port and a mouse port (e.g., Logitech™).

The memory unit 912 is used for storing computer executable instructions.

It will be appreciated that the memory unit 912 comprises in one embodiment an operating system module 914.

It will be appreciated by the skilled addressee that the operating system module 914 may be of various types.

In an embodiment, the operating system module 914 is Windows™ 8 manufactured by Microsoft™.

Each of the CPU 902, the display device 904, the input devices 906, the communication ports 908 and the memory unit 912 is interconnected via the data bus 910.

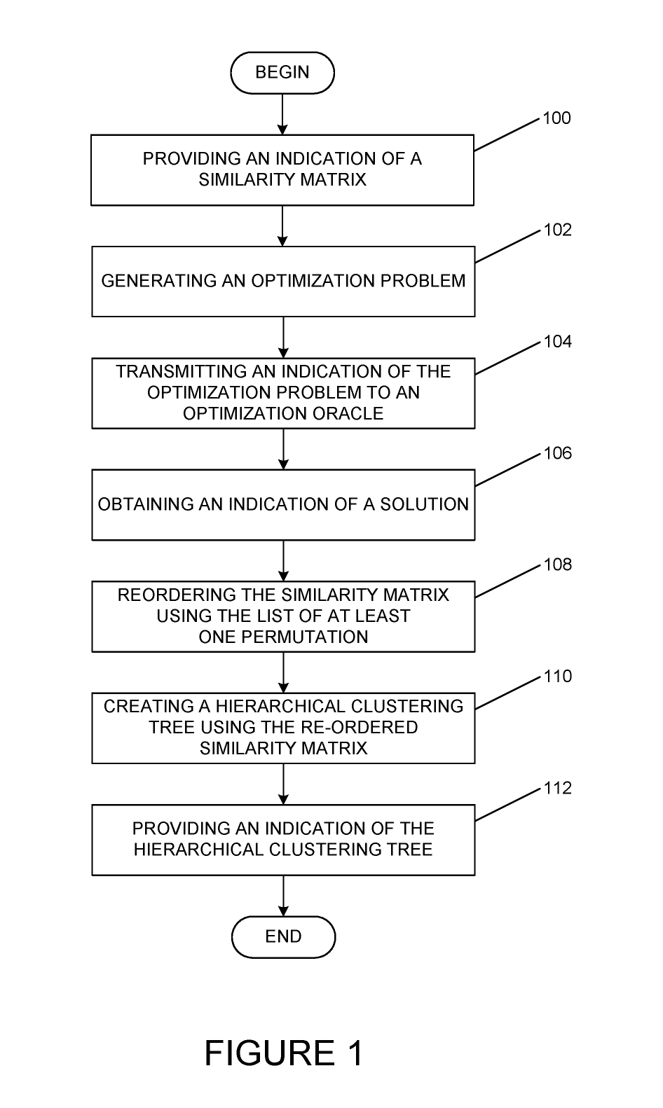

Now referring to FIG. 1, there is shown an embodiment of a method for determining a hierarchical clustering for a group comprising a plurality of items.

It will be appreciated that the computer-implemented method for determining a hierarchical clustering may be of great advantage for various applications.

For instance, the method may be used in financial services industry for generating low-risk portfolios of assets. Alternatively, the method disclosed herein may be used in market research to partition the general population of consumers into market segments for additional analysis and marketing activities. The method disclosed herein may also be used in social network analysis. It will be also appreciated that as a clustering technique, the method disclosed herein may be used in applications involving unsupervised machine learning.

It will be appreciated that the item may be, for instance, a return of an asset over time in the case where the method is used for generating a diversified portfolio that minimizes the risk.

In an alternative embodiment, the item may be consumers in the case where the method is used for market research.

According to processing step 100, an indication of a similarity matrix for a plurality of items is provided.

It will be appreciated that the indication of a similarity matrix for a plurality of items may be provided according to various embodiments.

In one embodiment, the indication of a similarity matrix for a plurality of items is provided by a user interacting with the processing device 900.

In another alternative embodiment, the indication of a similarity matrix for a plurality of items is obtained from the memory unit 912 of the processing device 900.

In another alternative embodiment, the indication of a similarity matrix for a plurality of items is obtained from a remote processing device, not shown. The remote processing device is operatively connected with the processing device 900.

In one embodiment, the remote processing device is operatively connected with the processing device 900 via a data network, not shown. The data network may comprise at least one of a local area network, a metropolitan area network and a wide area network. In one embodiment, the data network comprises the Internet.

It will be appreciated that the providing of the similarity matrix may comprise in one embodiment generating the similarity matrix using a list of a plurality of items.

The skilled addressee will appreciate that the generation of a similarity matrix is trivial and depends on an application.

The skilled addressee will further appreciate that the generation of the similarity matrix may be performed using the processing device 900 or another processing device operatively coupled to the processing device 900.

According to processing step 102, an optimization problem is generated for determining a list of at least one permutation of items in the similarity matrix such that the similarity matrix is quasi-block diagonalized with the at least one permutation of items.

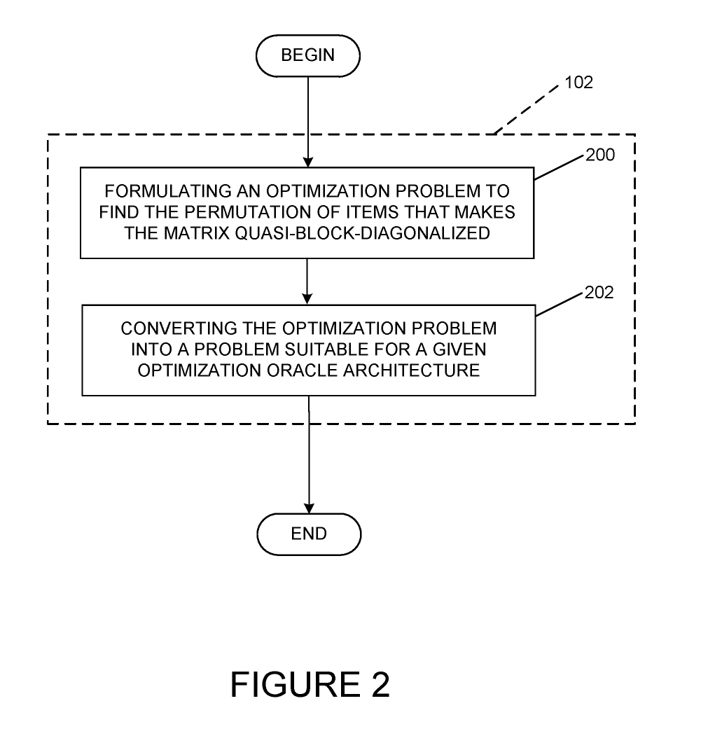

Now referring to FIG. 2, there is shown an embodiment for generating an optimization problem for determining a list of at least one permutation of items in the similarity matrix such that the similarity matrix is quasi-block diagonalized with the at least one permutation of items.

According to processing step 200, an optimization problem is formulated to find the permutations of items that make the matrix quasi-block diagonalized.

In accordance with an embodiment, the optimization problem comprises an objective function.

It will be appreciated that in one embodiment the objective function is translated in a Quadratic Unconstrained Binary Optimization problem (QUBO) having the following form:

$$min {\sum }_{i , j , k , l}^{ } {{A}_{ij} ( k - l )}^{2} {x}_{ik} {x}_{jl} + {c}_{1} {\sum }_{i}^{ } {( {\sum }_{k}^{ } {x}_{ik} - 1 )}^{2} + {C}_{2} {\sum }_{k}^{ } {( {\sum }_{i}^{ } {x}_{ik} - 1 )}^{2}$$

wherein Aᵢⱼ is the similarity matrix; xᵢₖ is a binary variable with one (1) meaning that, in the reordering of items, item i will be assigned position k. C₁ and C₂ are constant penalty coefficients and each of the summations following them is implementing one of the following constraints into the QUBO, a constraint is that for each i there exists exactly one k such that xᵢₖ=1, and another constraint is that for each k there exists exactly one i such that xᵢₖ=1

According to processing step 202, the optimization problem is converted into a problem suitable for a given optimization oracle architecture.

It will be appreciated that the optimization oracle architecture may comprise, for instance, a quantum annealer.

In fact, it will be appreciated that the optimization oracle comprises a digital computer embedding a binary quadratic programming problem as an Ising spin model, and an analog computer that carries out an optimization of a configuration of spins in the Ising spin model.

An embodiment of quantum annealer is the quadratic solver developed by D-Wave Systems.

The skilled addressee will appreciate that in such embodiment, the conversion into a problem suitable for such quantum annealer comprises generating an embedding pattern for embedding the optimization problem in the quantum annealer.

According to processing step 104, an indication of the optimization problem is transmitted to a given optimization oracle.

The skilled addressee will appreciate that the transmission of the indication of the optimization problem to the given optimization oracle depends on the given optimization oracle used.

The skilled addressee will appreciate that such processing step is known to the skilled addressee.

Still referring to FIG. 1 and according to processing step 106, an indication of a solution to the optimization problem is obtained from the given optimization oracle. It will be appreciated that the indication of a solution comprises the list of at least one permutation of items.

It will be appreciated that the obtaining of the indication of a solution depends on the optimization oracle used.

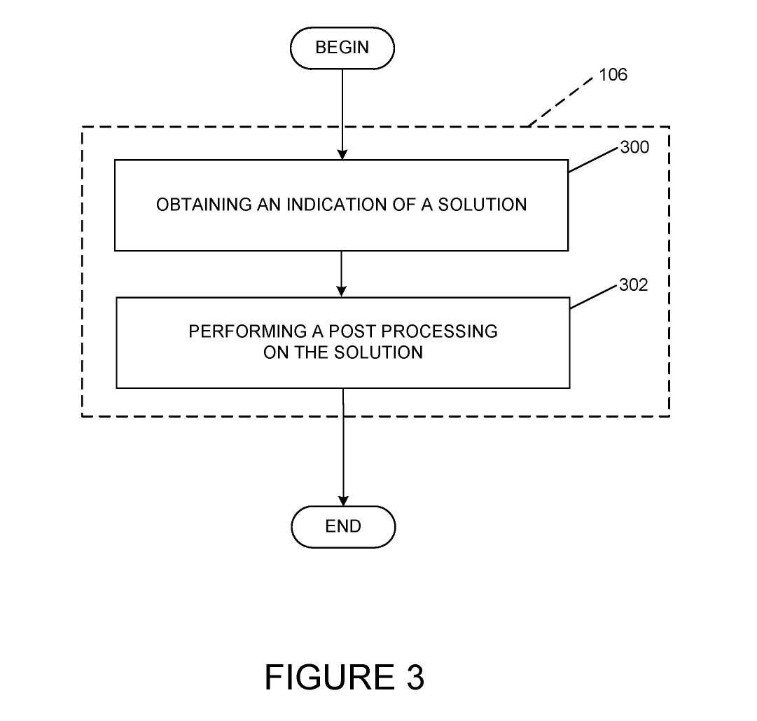

Now referring to FIG. 3, there is shown an embodiment for obtaining an indication of a solution to the optimization problem from the given optimization oracle.

According to processing step 300, an indication of a solution is obtained. It will be appreciated that the indication of a solution comprises the list of at least one permutation of items.

Still referring to FIG. 3 and according to processing step 302, a post-processing is performed on the solution comprising the list of at least one permutation of items.

It will be appreciated that the purpose of the post-processing is to improve the solution provided by the optimization oracle if this is possible. It is important to note that if the optimization oracle finds the optimal answer, the answer cannot be further improved.

More precisely and in one embodiment, the post-processing comprises a simple heuristic local search which may be used as a post-processing method.

Now referring back to FIG. 1 and according to processing step 108, the similarity matrix is reordered using the list of at least one permutation of items.

It will be appreciated that the processing step of reordering the similarity matrix using the list of at least one permutation of items is known to the skilled addressee.

According to processing step 110, a hierarchical clustering tree is created using the reordered similarity matrix.

As explained further below, it will be appreciated that the dividing of a node comprising a given number of items into two clusters comprises selecting a submatrix of the reordered similarity matrix associated with the given number of items, evaluating possible split points, choosing a given split point according to a criterion and generating the two clusters using the chosen split point. As explained further below, it will be appreciated that in one embodiment the criterion comprises minimizing a matrix measure associated with the selected submatrix.

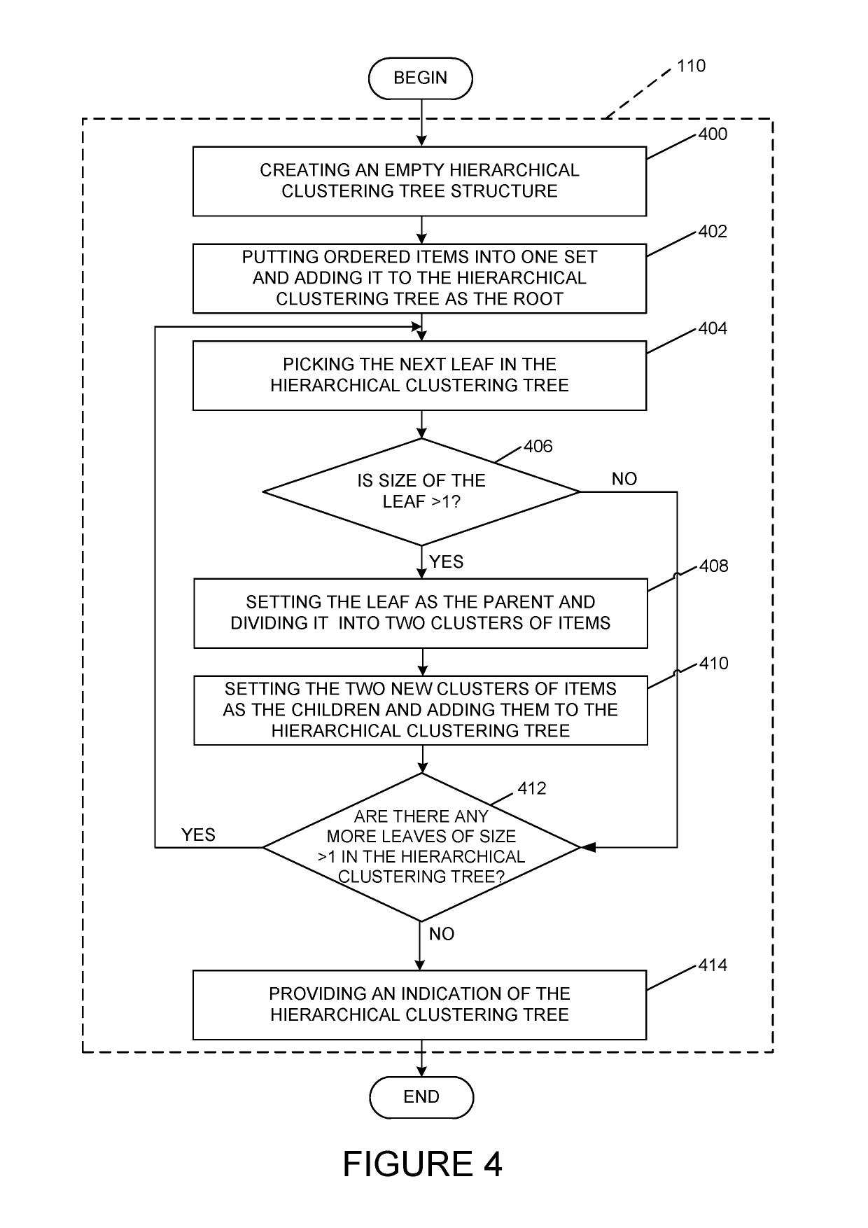

Now referring to FIG. 4, there is shown an embodiment for creating a hierarchical clustering tree based on the reordered similarity matrix.

According to processing step 400, an empty hierarchical clustering tree structure is created.

It will be appreciated that the empty hierarchical clustering tree structure may be presented according to various formats known to the skilled addressee.

In fact, it will be appreciated that the hierarchical clustering tree structure is a specific data structure used for storing the hierarchy of clusters. When created, the hierarchical clustering tree structure is empty, but when it is used, its size becomes dependent on the number of items comprised in the group.

According to processing step 402, all the items are put into one set and added to the hierarchical clustering tree as the root of the hierarchical clustering tree structure.

According to processing step 404, a next leaf in the hierarchical clustering tree is picked.

According to processing step 406, a check is made in order to find out if the size of the leaf is greater than one (1).

This means that more than one item are located in the leaf.

In the case where the size of the leaf is greater than one (1) and according to processing step 408, the leaf is set as the parent and divided into two clusters of items.

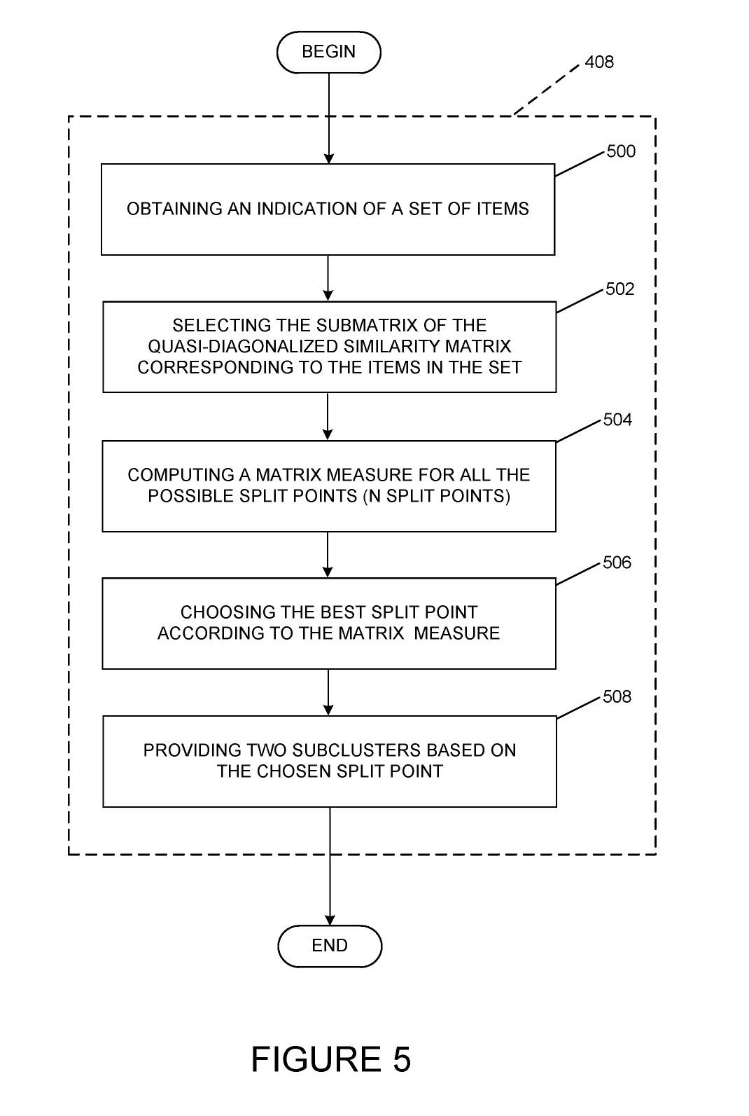

Now referring to FIG. 5, there is shown an embodiment for setting the leaf as the parent and dividing it into two clusters of items.

According to processing step 500, an indication of a set of items is obtained.

According to processing step 502, the submatrix of the quasi-diagonalized similarity matrix corresponding to the items in the set of items is selected.

According to processing step 504, a matrix measure is computed for all the possible split points (N split points).

The objective of this processing step is to split the submatrix of the quasi-diagonalized similarity matrix into a 2×2 block-matrix and to identify the split point for which the matrix measure is minimized.

In fact, it will be appreciated that a split point can be referred to as the position at which the set of items is split into two parts to form the 2×2 block-matrix.

It will be appreciated that the matrix measure may be of various types. For instance, the matrix measure comprises the mean absolute value of off-diagonal blocks' entries of the selected submatrix.

In an alternative embodiment, the matrix measure comprises the Frobenius norm of the off-diagonal blocks' entries of the selected submatrix.

According to processing step 506, a best split point is chosen according to the matrix measure.

It will be appreciated that a best split point can be referred to as a split point that will minimize the matrix measure. It will be appreciated that this split point will minimize the loss of information when discarding the off-diagonal blocks of the 2×2 block-matrix.

According to processing step 508, two subclusters are provided based on the chosen split point.

Now referring back to FIG. 4 and according to processing step 410, the two new clusters of items are set as the children and added to the hierarchical tree.

According to processing step 412, a check is made in order to find out if there are any more leaves of size greater than one (1) in the hierarchical clustering tree.

In the case where there is at least one leaf of size greater than one (1) in the hierarchical clustering tree and according to processing step 404, the next leaf in the hierarchical clustering tree is picked.

In the case where there is not one more leaf of a size greater than one (1) in the hierarchical clustering tree and according to processing step 414, an indication of the hierarchical clustering tree is provided.

The hierarchical clustering tree may have various formats as known to the skilled addressee.

For instance, the hierarchical clustering tree may be implemented using a data structure representing a node, containing the set of items as well as links to the node's parent node and child nodes.

Now referring to FIG. 1 and according to processing step 112, an indication of the hierarchical clustering tree is provided.

It will be appreciated that the indication of the hierarchical clustering tree may be provided according to various embodiments.

In one embodiment, the indication of the hierarchical clustering tree is stored in the memory unit 912 of the processing device 900.

In another embodiment, the indication of the hierarchical clustering tree is transmitted to a remote processing device, not shown, operatively connected to the processing device 900. In one embodiment, the remote processing device is connected to the processing device 900 via a data network, not shown. The data network may be selected from a group consisting of local area networks, metropolitan area networks and wide area networks. In one embodiment, the data network comprises the Internet.

### Application of the Method Disclosed Herein

As mentioned above, it will be appreciated that the computer-implemented method disclosed above may be used advantageously for determining allocation weights for a plurality of items. As mentioned above and in one embodiment, the item may be an asset with corresponding historical time value over time.

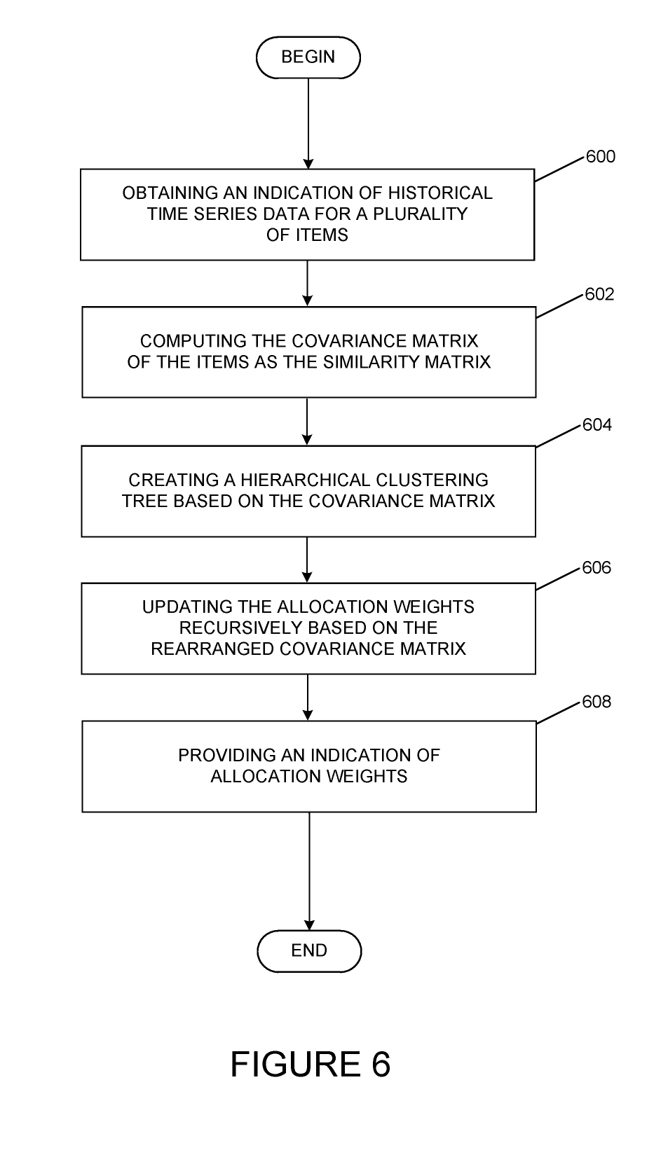

Now referring to FIG. 6, there is shown an embodiment of a method for providing an indication of allocation weights for a plurality of items.

According to processing step 600, an indication of historical time series data is obtained for a plurality of items.

In one embodiment, the plurality of items are assets that are publicly traded. In an alternative embodiment, the plurality of assets are commodities futures.

According to processing step 602, the covariance matrix of the items is computed as a similarity matrix.

The skilled addressee will appreciate that the purpose of computing the covariance matrix is to provide a similarity matrix between the items.

It will be further appreciated that the computing of the covariance matrix is trivial for the skilled addressee.

According to processing step 604, a hierarchical clustering tree is created based on the covariance matrix.

It will be appreciated that the hierarchical clustering tree may be created according to various embodiments.

In one embodiment, the hierarchical clustering tree is created using the method disclosed herein.

Still referring to FIG. 6 and according to processing step 606, the allocation weights are recursively updated based on the rearranged covariance matrix.

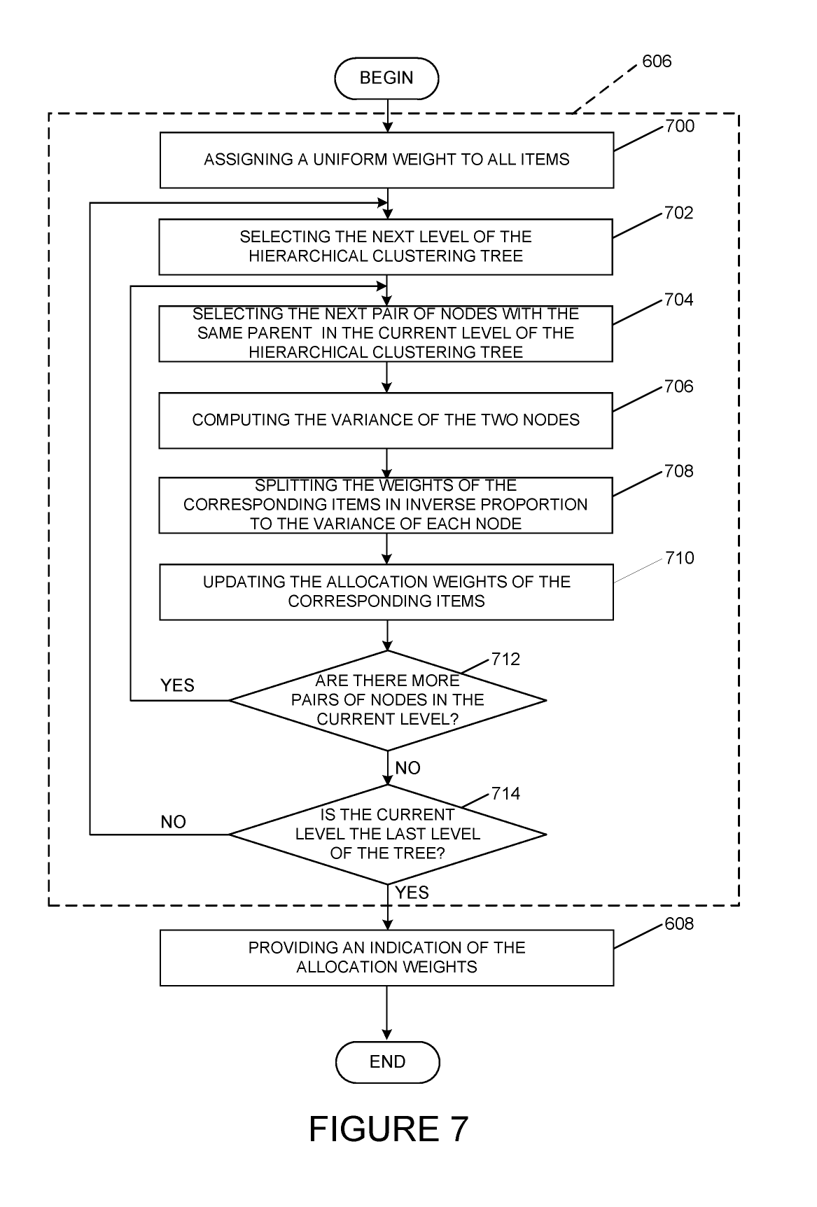

Now referring to FIG. 7, there is shown an embodiment for updating the allocation weights recursively based on the rearranged covariance matrix.

According to processing step 700, a uniform weight is assigned to all items of the plurality of items.

The skilled addressee will appreciate that the uniform weight may be equal to one (1) in one embodiment.

According to processing step 702, a next level of the hierarchical clustering tree is selected.

According to processing step 704, a next pair of nodes is selected with the same parent in the current level of the hierarchical clustering tree.

According to processing step 706, the variance of the two nodes is computed.

It will be appreciated that the variance of the two nodes may be computed according to various embodiments.

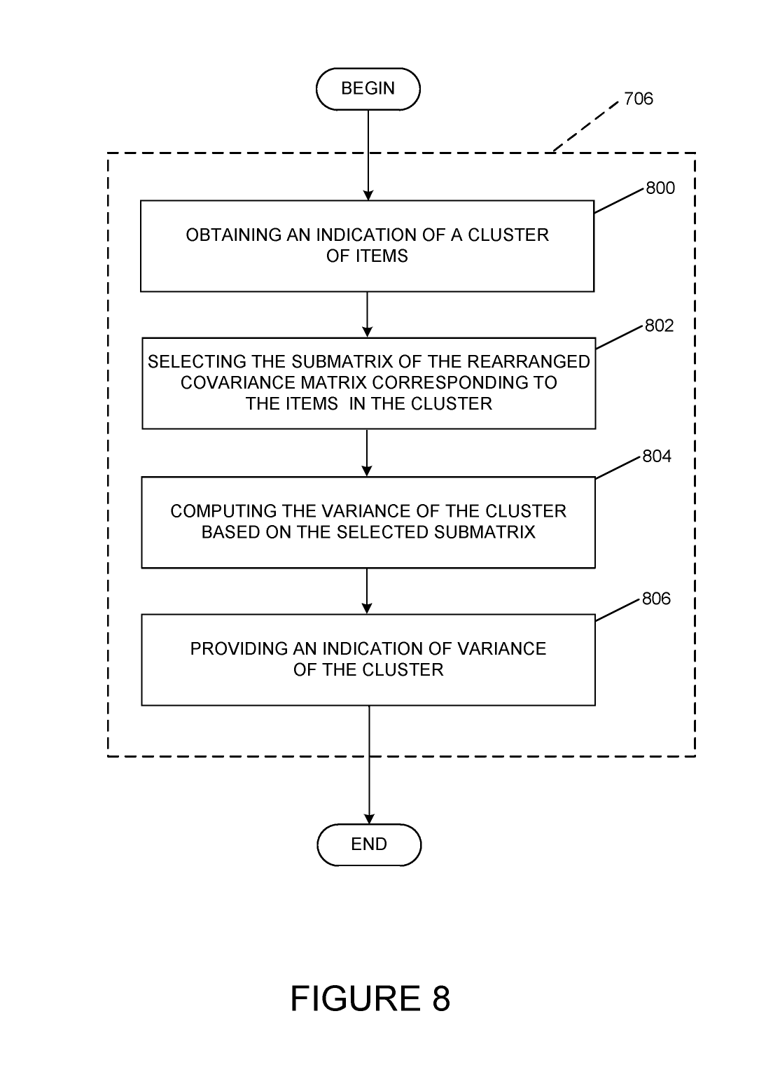

Now referring to FIG. 8, there is shown an embodiment for computing the variance of the two nodes.

According to processing step 800, an indication of a cluster of items is obtained.

It will be appreciated that the indication of a cluster of items may be obtained according to various embodiments.

According to processing step 802, the submatrix of the rearranged covariance matrix corresponding to the items in the cluster is selected.

According to processing step 804, the variance of the cluster is computed based on the selected submatrix. The skilled addressee will appreciate that the computation of the variance of the cluster is performed according to a known formula.

According to processing step 806, an indication of the variance of the cluster is provided.

Now referring back to FIG. 7 and according to processing step 708, the weights of the corresponding items are split in inverse proportion to the variance of each node.

According to processing step 710, the allocation weights of the corresponding items are updated.

According to processing step 712, a test is performed in order to find out if there are more pairs of nodes in the current level of the hierarchical clustering tree.

In the case where there are more pairs of nodes in the current level of the hierarchical clustering tree and according to processing step 704, the next pair of nodes with the same parent in the current level of the hierarchical clustering tree is selected.

In the case where there are not more pairs of nodes in the current level and according to processing step 714, a test is performed in order to find out if the current level is the last level of the hierarchical clustering tree.

In the case where the current level is not the last level of the hierarchical clustering tree and according to processing step 702, the next level of the hierarchical clustering tree is selected.

In the case where the current level is the last level of the hierarchical clustering tree and according to processing step 608, an indication of the allocation weights is provided.

Now referring back to FIG. 6 and according to processing step 608, an indication of the allocation weights is provided.

It will be appreciated that the providing of the allocation weights depends on an application sought and that it may be performed according to various embodiments.

In one embodiment, the indication of the allocation weights is displayed to a user interacting with the processing device 900.

In an alternative embodiment, the indication of the allocation weights is transmitted to a remote processing device, not shown, operatively connected to the processing device 900. In one embodiment, the remote processing device is connected to the processing device 900 via a data network, not shown. The data network may be selected from a group consisting of local area networks, metropolitan area networks and wide area networks. In one embodiment, the data network comprises the Internet.

It will be appreciated that an advantage of the method in this particular application is that the determined weight allocation tends to lower out-of-sample risk. In the case where the items are assets, the determined weight allocation will help minimizing the risk of returns.

Another advantage of the method disclosed herein is that it provides a global optimum answer for quasi-block-diagonalization of the similarity matrix. Both the agglomerative approach and other conventional divisive approaches lead to a suboptimal answer for the problem of finding a quasi-block-diagonalized similarity matrix.

Another advantage of the method disclosed herein is that it is not biased towards cluster sizes. Therefore it can provide a more suitable hierarchical clustering tree based on the original structure of the data.

Another advantage of the method disclosed herein is that it provides higher quality results in a shorter amount of time compared to prior-art methods for determining weight allocation.

Another advantage of the method disclosed herein for determining weight allocation is that it does not need the covariance matrix to be non-singular.

Another advantage of the method disclosed herein for determining weight allocation is that it is more stable against numerical errors since the method disclosed does not involve inverting the covariance matrix.

An advantage of the method disclosed herein when applied for determining weight allocation is that the determined weight allocation minimizes risk. In the case where the items are assets, the determined weight allocation will help minimizing the risk of returns.

Now referring to FIG. 9, it will be appreciated that the memory unit 912 further comprises an application for determining a hierarchical clustering for a group comprising a plurality of items 916.

The application for determining a hierarchical clustering for a group comprising a plurality of items 916 comprises instructions for providing an indication of a similarity matrix for a plurality of items.

The application for determining a hierarchical clustering for a group comprising a plurality of items 916 further comprises instructions for generating an optimization problem for determining a list of at least one permutation of items in the similarity matrix such that the similarity matrix is quasi-block diagonalized with the at least one permutation of items.

The application for determining a hierarchical clustering for a group comprising a plurality of items 916 further comprises instructions for transmitting an indication of the optimization problem to a given optimization oracle operatively connected to the processing device using the communication port, wherein the optimization oracle comprises a digital computer embedding a binary quadratic programming problem as an Ising spin model and an analog computer that carries out an optimization of a configuration of spins in the Ising spin model.

The application for determining a hierarchical clustering for a group comprising a plurality of items 916 further comprises instructions for obtaining an indication of a solution to the optimization problem from the given optimization oracle, the indication of a solution comprising the list of at least one permutation of items.

The application for determining a hierarchical clustering for a group comprising a plurality of items 916 further comprises instructions for reordering the similarity matrix using the list of at least one permutation of items.

The application for determining a hierarchical clustering for a group comprising a plurality of items 916 further comprises instructions for creating a hierarchical clustering tree using the reordered similarity matrix wherein the dividing of a node comprising a given number of items into two clusters comprises selecting a submatrix of the reordered similarity matrix associated with the given number of items, evaluating possible split points, choosing a given split point according to a criterion and generating the two clusters using the chosen split point.

The application for determining a hierarchical clustering for a group comprising a plurality of items 916 further comprises instructions for providing an indication of the hierarchical clustering tree.

It will be appreciated that the memory unit 912 may further comprise data 918 used by the application for determining a hierarchical clustering for a group comprising a plurality of items.

It will be also appreciated that there is also disclosed a non-transitory computer-readable storage medium. The non-transitory computer-readable storage medium is used for storing computer-executable instructions which, when executed, cause a processing device to perform a method for determining a hierarchical clustering for a group comprising a plurality of items, the method comprising providing an indication of a similarity matrix for a plurality of items; generating an optimization problem for determining a list of at least one permutation of items in the similarity matrix such that the similarity matrix is quasi-block diagonalized with the at least one permutation of items; transmitting an indication of the optimization problem to a given optimization oracle, wherein the optimization oracle comprises a digital computer embedding a binary quadratic programming problem as an Ising spin model and an analog computer that carries out an optimization of a configuration of spins in the Ising spin model; obtaining an indication of a solution to the optimization problem from the given optimization oracle, the indication of a solution comprising the list of at least one permutation of items; reordering the similarity matrix using the list of at least one permutation of items; creating a hierarchical clustering tree using the reordered similarity matrix wherein the dividing of a node comprising a given number of items into two clusters comprises selecting a submatrix of the reordered similarity matrix associated with the given number of items, evaluating possible split points, choosing a given split point according to a criterion and generating the two clusters using the chosen split point and providing an indication of the hierarchical clustering tree.

Although the above description relates to specific embodiments as presently contemplated by the inventors, it will be understood that the invention in its broad aspect includes functional equivalents of the elements described herein.

1. A computer-implemented method for determining a hierarchical clustering for a group comprising a plurality of items, the method comprising:
use of a processing device for:
providing an indication of a similarity matrix for a plurality of items;
generating an optimization problem for determining a list of at least one permutation of items in the similarity matrix such that the similarity matrix is quasi-block diagonalized with the at least one permutation of items;
transmitting an indication of the optimization problem to a given optimization oracle, wherein the optimization oracle comprises a digital computer embedding a binary quadratic programming problem as an Ising spin model and an analog computer that carries out an optimization of a configuration of spins in the Ising spin model;
obtaining an indication of a solution to the optimization problem from the given optimization oracle, the indication of a solution comprising the list of at least one permutation of items;
reordering the similarity matrix using the list of at least one permutation of items;
creating a hierarchical clustering tree using the reordered similarity matrix wherein the dividing of a node comprising a given number of items of the hierarchical clustering tree into two clusters comprises selecting a submatrix of the reordered similarity matrix associated with the given number of items, evaluating possible split points, choosing a given split point according to a criterion and generating the two clusters using the chosen split point; and
providing an indication of the hierarchical clustering tree.

2. The method as claimed in claim 1, wherein the indication of a similarity matrix is provided by a user interacting with the processing device.

3. The method as claimed in claim 1, wherein the indication of a similarity matrix is obtained from a memory unit of the processing device.

4. The method as claimed in claim 1, wherein the indication of a similarity matrix is obtained from a remote processing device operatively connected with the processing device using a data network.

5. The method as claimed in claim 1, wherein the providing of an indication of a similarity matrix for a plurality of items comprises generating the similarity matrix using a list of the plurality of items.

6. The method as claimed in claim 1, wherein the optimization problem is converted into an optimization problem suitable for the optimization oracle.

7. The method as claimed in claim 1, wherein the optimization problem comprises an objective function.

8. The method as claimed in claim 7, wherein the objective function is translated in a quadratic unconstrained binary optimization problem.

9. The method as claimed in claim 1, wherein the obtaining of an indication of a solution to the optimization problem from the given optimization oracle comprises performing a post-processing to improve the solution.

10. The method as claimed in claim 1, wherein the criterion comprises minimizing a matrix measure associated with the selected submatrix.

11. The method as claimed in claim 10, wherein the matrix measure comprises a mean absolute value of off-diagonal blocks' entries of the selected submatrix.

12. The method as claimed in claim 10, wherein the matrix measure comprises a Frobenius norm of off-diagonal blocks' entries of the selected submatrix.

13. The method as claimed in claim 1, wherein the indication of the hierarchical clustering tree is stored in a memory unit of the processing device.

14. The method as claimed in claim 1, wherein the indication of the hierarchical clustering tree is transmitted to a remote processing device operatively connected to the processing device.

15. A processing device for determining a hierarchical clustering for a group comprising a plurality of items, the processing device comprising:
a central processing unit;
a display device;
a communication port;
a memory unit comprising an application for determining a hierarchical clustering for a group comprising a plurality of items, the application comprising:
instructions for providing an indication of a similarity matrix for a plurality of items,
instructions for generating an optimization problem for determining a list of at least one permutation of items in the similarity matrix such that the similarity matrix is quasi-block diagonalized with the at least one permutation of items,
instructions for transmitting an indication of the optimization problem to a given optimization oracle operatively connected to the processing device using the communication port, wherein the optimization oracle comprises a digital computer embedding a binary quadratic programming problem as an Ising spin model and an analog computer that carries out an optimization of a configuration of spins in the Ising spin model,
instructions for obtaining an indication of a solution to the optimization problem from the given optimization oracle, the indication of a solution comprising the list of at least one permutation of items,
instructions for reordering the similarity matrix using the list of at least one permutation of items,
instructions for creating a hierarchical clustering tree using the reordered similarity matrix wherein the dividing of a node comprising a given number of items into two clusters comprises selecting a submatrix of the reordered similarity matrix associated with the given number of items, evaluating possible split points, choosing a given split point according to a criterion and generating the two clusters using the chosen split point and
instructions for providing an indication of the hierarchical clustering tree; and
a data bus for interconnecting the central processing unit, the display device, the communication port and the memory unit.

16. A non-transitory computer-readable storage medium for storing computer-executable instructions which, when executed, cause a processing device to perform a method for determining a hierarchical clustering for a group comprising a plurality of items, the method comprising:
providing an indication of a similarity matrix for a plurality of items;
generating an optimization problem for determining a list of at least one permutation of items in the similarity matrix such that the similarity matrix is quasi-block diagonalized with the at least one permutation of items;
transmitting an indication of the optimization problem to a given optimization oracle, wherein the optimization oracle comprises a digital computer embedding a binary quadratic programming problem as an Ising spin model and an analog computer that carries out an optimization of a configuration of spins in the Ising spin model;
obtaining an indication of a solution to the optimization problem from the given optimization oracle, the indication of a solution comprising the list of at least one permutation of items;
reordering the similarity matrix using the list of at least one permutation of items;
creating a hierarchical clustering tree using the reordered similarity matrix wherein the dividing of a node comprising a given number of items into two clusters comprises selecting a submatrix of the reordered similarity matrix associated with the given number of items, evaluating possible split points, choosing a given split point according to a criterion and generating the two clusters using the chosen split point; and
providing an indication of the hierarchical clustering tree.

17. A method for determining allocation weights for a plurality of items, the method comprising:
obtaining an indication of historical time series data for a plurality of items;
computing a covariance matrix of the plurality of items to provide a similarity matrix between the items of the plurality of items;
generating a hierarchical tree for the plurality of items according to the computer-implemented method claimed in claim 1 using the similarity matrix;
updating allocation weights recursively using the generated hierarchical tree;
providing an indication of the allocation weights.
